(19) United States
(12) Patent Application Publication
(10) Pub. No.: US 2021/0059138 A1
(43) Pub. Date: Mar. 4, 2021

(54) METHOD AND SYSTEM FOR FEEDING AND HYDRATING PLANTS

(71) Applicant: SIDON LLC, Cedar City, UT (US)

(72) Inventors: Richard B. Muir, San Diego, CA (US); Dennis M. Clements, Cedar City, UT (US)

(21) Appl. No.: 16/991,894

(22) Filed: Aug. 12, 2020

Related U.S. Application Data
(60) Provisional application No. 62/885,513, filed on Aug. 12, 2019.

(51) Int. Cl. A01G 29/00; B64G 4/00; A01G 7/04

(52) U.S. Cl. CPC A01G 29/00; A01G 7/045; B64G 4/00

(57) ABSTRACT

Systems and methods for growing plants. The systems and methods can be used for growing plants in low, micro, or zero gravity environments. An injection device can inject a fluid or growth medium into the stem or root of a plant. A plant can also be supported on a platform and a light placed below the plant, or in a direction opposite gravity or a acceleration force to promote plant growth in a direction opposite gravity or the acceleration force.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57. This application claims the benefit of priority to U.S. Provisional Application No. 62/885,513, filed Aug. 12, 2019, the entire contents of which are hereby incorporated by reference.

### BACKGROUND

This application relates to methods for growing, feeding and/or hydrating plants.

### SUMMARY

In one aspect described herein, a system for growing plants comprises an injection device adapted to pierce a surface of a plant; a supply line in fluid connection with the injection device, the supply line adapted to carry a fluid to the injection device; and a fluid source in fluid communication with the supply line, the fluid source adapted to apply a motive force to a fluid in order to move the fluid through the supply line, the injection device, and into the plant.

In some embodiments, the injection device is a needle

In some embodiments, the injection device is a microneedle array.

In some embodiments, the fluid comprises nutrients to promote plant growth

In some embodiments, the system further comprising a plant having a root and at least one stem, and wherein the injection device is inserted into an injection site in the stem near the root.

In some embodiments, the injection device is inserted into the injection site at a downward angle with respect to the direction of stem growth.

In some embodiments, the injection device is inserted into the injection site at an upward angle with respect to the direction of stem growth.

In some embodiments, the plant is disposed in a low or zero gravity environment.

In another aspect described herein, a system for growing plants, the system comprises a frame for supporting a plant; a root support for housing a root system of the plant, the root support connected to the frame; a light source disposed below the frame at a determined distance from the frame so as to promote growth of the plant downward toward the light.

In some embodiments, the root support is connected to the frame on an underside of the frame.

In some embodiments, the root support is connected to the frame on a top side of the frame.

In some embodiments, the light source is disposed at the determined distance from the frame in a direction opposite the direction of gravity.

In some embodiments, the light source comprises a plurality of light emitting elements, wherein the light emitting elements are configured to emit different frequencies of light.

In some embodiments, the system further comprises a fluid source mounted to the frame; a supply line in fluid connection with the fluid source, the supply line adapted to carry a fluid from the fluid source; and an injection device adapted to pierce a surface of a plant near the root support, wherein the fluid source adapted to apply a motive force to a fluid in order to move the fluid through the supply line, the injection device, and into the plant.

In another aspect, a method for growing a plant comprises securing a root ball of a plant within a root support, the root support connected to a platform; illuminating a light source, the light source being disposed below the root support in a direction opposite the force of gravity; and promoting growth of the plant toward the light source in the direction opposite the force of gravity.

In another aspect, the method further comprises inserting an injection device into a stem of the plant near the root ball; connecting a supply line to the injection device, the supply line comprising a lumen to contain a fluid; connecting the supply line to a fluid source, the fluid source comprising a motive force for moving the fluid; and injecting the fluid into the plant by the fluid source, supply line, and the injection device.

### BRIEF DESCRIPTION OF THE DRAWINGS

The above-mentioned aspects, as well as other features, aspects, and advantages of the present technology will now be described in connection with various implementations, with reference to the accompanying drawings. The illustrated implementations, however, are merely examples and are not intended to be limiting. Throughout the drawings, similar symbols typically identify similar components, unless context dictates otherwise. Note that the relative dimensions of the following figures may not be as depicted, and the drawings may not be drawn to scale.

FIG. 1A depicts an exemplary system for feeding a plant using a needle.

FIG. 1B depicts an exemplary system for feeding a plant using an array of microneedles.

FIG. 1C depicts an exemplary system for feeding a plant using a needle inserted into the base of a plant.

FIG. 2 depicts an exemplary system for growing a plant toward a light source located below a root system of a plant.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein and as illustrated in the figures, can be arranged, substituted, combined and designed in a wide variety of configurations, all of which are explicitly contemplated and made part of this disclosure.

A plant requires water and nutrients to grow and to be fruitful. Generally, a plant absorbs water and nutrients through its root system. In some environments, such as an arid environment, a low water environment, a low gravity or zero gravity environment, or other environment, a root system may not be able to absorb water, minerals, and or other necessary materials, or may only be able to absorb these with a reduced efficiency. It can be advantageous to provide water and/or nutrients directly into vascular or other tissues of a plant, by, for example, feeding a plant trans-dermally, that is, providing water and/or nutrients through the epidermis and/or dermis of the plant.

Transdermal delivery described herein can be accomplished using an injection device, such as a needle, as depicted, or using one or more other mechanisms which can pierce or permeabilize the outer surface of a plant to allow for water, nutrients, and/or other desired substances to move through the outer wall or surface of a plant. This can include, for example, using a high pressure system using pressure to pierce the outer surface of a plant, or using an electrical, light-based, chemical, or mechanical permeabilizer to open an aperture in the plant's outer surface. In some embodiments described below, a needle or array of needles is depicted, the scope of the present disclosure is not limited to the use of needles for injecting substances into plants.

In some embodiments, such as low or zero gravity, or in orbital or space environments, a plant may not have access to soil from which to absorb water and nutrients. This can be the case where moving soil from a terrestrial source into orbit or space can be heavy, difficult, and expensive. It can also be difficult to water a plant in a low or zero gravity environment. By injecting water and nutrients directly into a plant's vascular system, the plant's uptake of water and nutrients can be accomplished without need for a soil or for absorption through the roots.

Aspects described herein can also relate to methods and systems for growing plants toward a light source, and in a direction which opposes gravity. Plants generally grow upward toward the sun, which is the primary light source for most plants. Thus, stems and leaves of plants generally grow in a direction opposite the downward force of gravity. A plant can advantageously be located with a root system above a light source, where the only light source is below the root system, or in the direction of gravity. As a plant grows toward the light based on phototropic effects, water and nutrients can be moved more easily within the plant, specifically in xylem, as the action for flowing xylem in this case moves water and nutrients in the same direction as the force of gravity, rather than in the opposing direction. This can make it possible to increase plant size, plant yield, plant health, and the like.

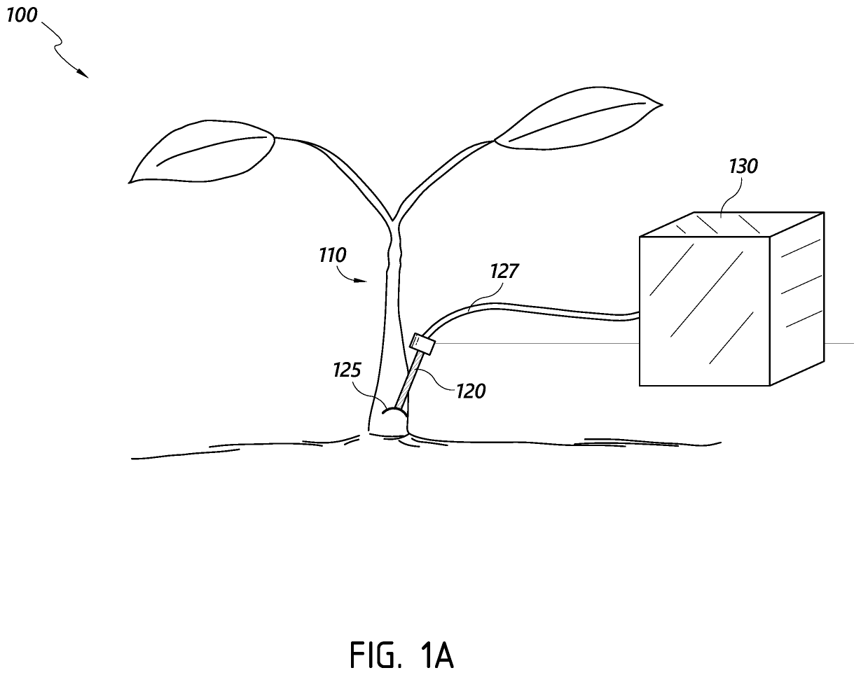

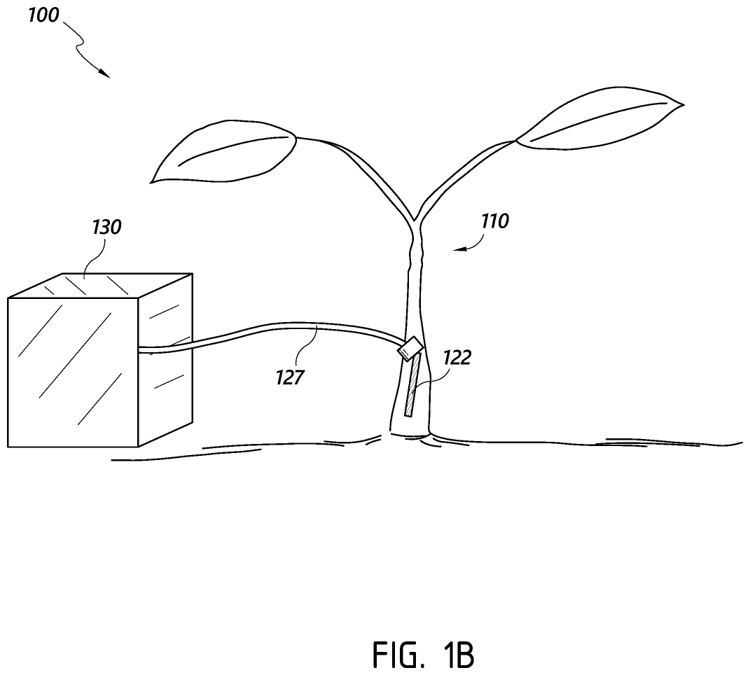

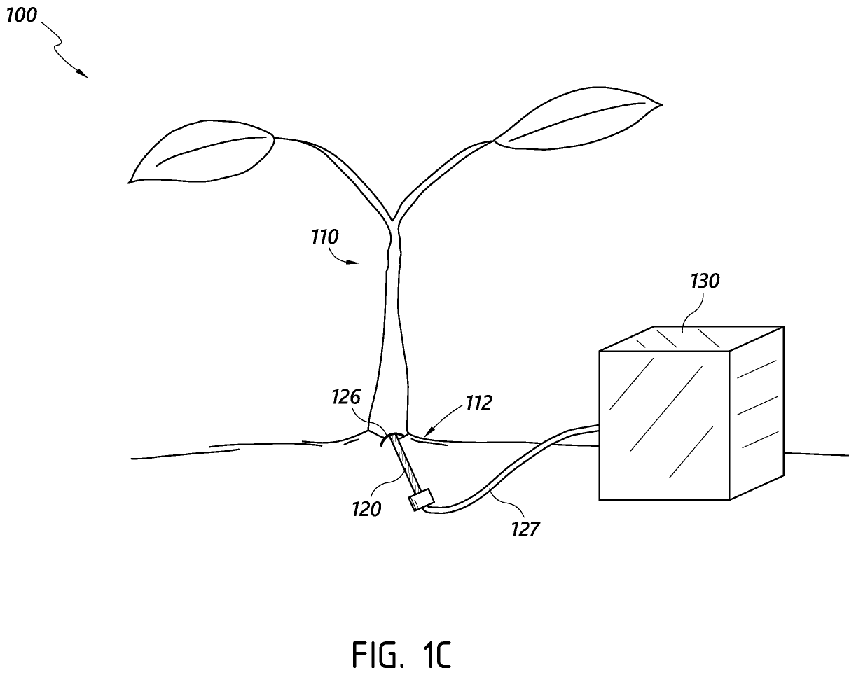

FIG. 1A depicts an embodiment of a plant being fed with an exemplary needle system. A feeding system 100 includes a plant 110, into which a needle 120 is inserted. The needle 120 comprises a hollow tip, a lateral hole along the barrel, or a combination of both, through which water and nutrients can be delivered to the plant. The needle can comprise a hollow inner lumen through which liquid flows. The lumen is connected to a supply line 127, which, in turn is connected to a fluid source 130.

In some embodiments, the needle can be an array of needles which penetrate the surface of the plant. In some embodiments, the feeding system 100 can comprise a plurality of needles 120 and supply lines 127 in communication with the fluid source 130. The plurality of needles 120 can penetrate the surface of the plant at multiple locations. In some embodiments, the needles 120 can be inserted on opposite sides of the plant 100, can be inserted with one needle 120 inserted at a point higher than another needle 120. In some embodiments, the plant may have multiple stems extending from a common root system, and separate needles 120 can be inserted into the multiple stems.

In some embodiments, the needle 120 can include a permeabilizing device (not shown) which aids in permeabilizing the surface of the plant, such as an electrical, chemical, or mechanical permeabilizing device. In some embodiments, for example, where a permeabilizing device is used, the supply line 120 can be connected to a patch or an adhesive device which can receive fluid from the supply line 127 and transmit the fluid to and through the surface of the plant with the help of the permeabilizing device.

In some embodiments, the needle 120 can be inserted into the plant 100 such that it can deliver a fluid into the xylem tissue or phloem tissue, as desired.

The supply line 127 can be hollow tubing in fluid communication with the lumen of the needle 120 and the fluid source 130. The fluid source 130 can be a vessel, reservoir, or other container which can hold water and/or nutrients for plant feeding and hydration. The fluid source 130 can generate a pressure differential to move fluid from the fluid source 130 to the needle 120. This can be accomplished by gravity, by a mechanical, pneumatic, electrical component, or other mechanism.

The fluid source 130 can additionally be configured to meter water and/or nutrients to the plant using an electromechanical or computerized system. The metering can be calibrated specifically for each plant or type of plant. In some embodiments, the electromechanical or computerized system can receive feedback from one or more sensors, such as humidity, temperature, etc., in order to vary the metering of water and/or nutrients to the plant as desired.

The needle 120 is inserted into an insertion point 125 on a stem or stalk of the plant 110. In some embodiments, the insertion point 125 is in the stem at a point near the root ball, or can be in the root ball of a plant. The needle 120 is inserted such that the fluid delivered by the needle is delivered to a space with the vascular system of the plant such that the plants vascular system can receive and transport water and/or nutrients within the plant as needed. The needle 120 can be inserted into the insertion point 125 such that the needle is inserted at a downward angle with respect to the direction of the stem growth.

FIG. 1B depicts an embodiment of a plant 100 being fed with an exemplary microneedle system. The system 100 includes a microneedle array 122 attached to an epidermis or outer surface of the plant 110. The microneedle array 122 can include a plurality of penetrating ports and a channel for fluid flow into the holes made by the microneedles. The microneedle array 122 is in fluid communication with the fluid source 130 via the supply line 127. The microneedle array 122 can be a strip or patch, of a variety of sizes and shapes. In some embodiments, the microneedle array 122 can be attached to the stalk, stem, or root ball of the plant 110 in a transverse or longitudinal direction. In some embodiments, the microneedle array 122 can be circumferentially disposed around the stem or stalk of the plant, and can be made using resilient or flexible material to allow for growth of the plant without dislodging the microneedle array 122, or without constricting the growth of the plant due to the microneedle array 122.

FIG. 1C depicts an embodiment of a plant being fed with an exemplary needle system. The system 100 can be similar to that described elsewhere herein, and includes a needle 120 inserted into an insertion point 126. The insertion point 126 is located at a base of the plant, for example, where the stem and the roots connect. In some embodiments, the insertion point 126 is in the root ball at a point proximate the stem connection to the roots. As depicted, the needle 120 can be inserted at an upward angle with respect to the orientation of the plant. That is, the needle 120 can be oriented such that the flow of fluid from the supply line 127 through the lumen of the needle 120 is generally upward, or in the general direction as the growth of the stem.

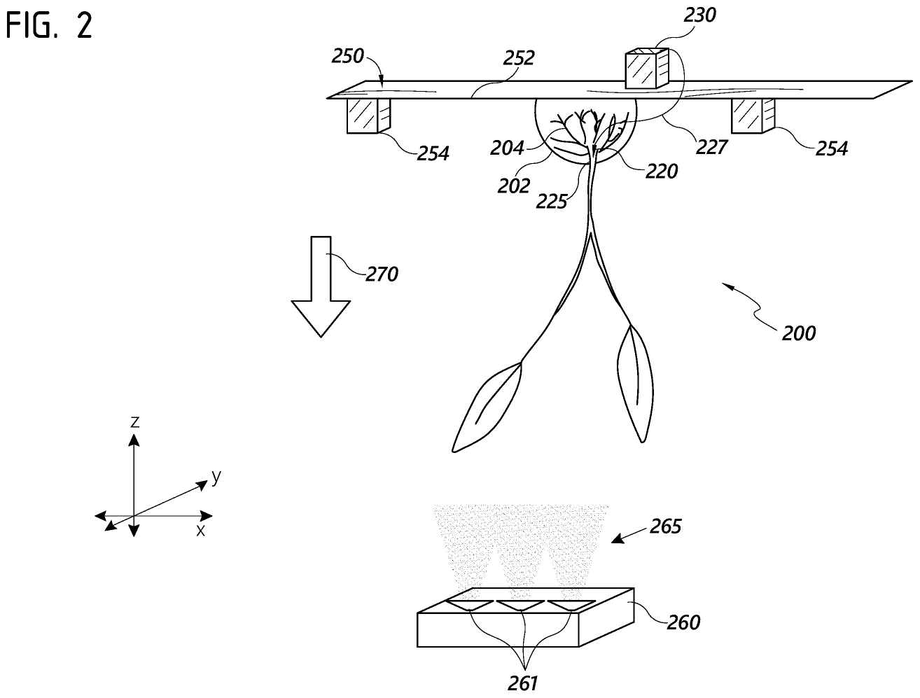

FIG. 2 depicts an exemplary system for growing a plant in a downward direction. A system 200 comprises a plant 210, a frame or support 250, and a light source 260. The plant 210 has a root ball 204 which is contained or supported within or by a root support 202. The root support 202 can be an amount of soil within a container, or can be another container without soil which provides protection to the roots of the plant 210. The root support 202 can be mounted on an underside of the support 250, or can be mounted on the top side of the support 250 and the plant 210 can grow downward from the top side of the support 250.

The support 250 is disposed above the light source 260. The support 250 includes support members 254, which can be cross pieces, struts, scaffolding, a frame, or any other type of structure to maintain the support 250 above the light source. As used herein, above can mean at a distance in the z-direction as shown on FIG. 2. In some embodiments, the support 250 is located at a position relative to the light source 260 in a direction opposite the direction of a net force 270. The net force 270 can be provided by gravity, or by an acceleration, such as a centrifugal or other acceleration placed on the system 250. In some embodiments, the net force 270 can be minimal or zero, such as when growing a plant in an orbital or space environment. The distance of the light source 260 from the support 250 can be set based on the type of plant, the type of the light source, or based on other factors.

The light source 260 can include one or more light emitting elements 261 which emit light 265, such as LEDs, halogen lights, incandescent bulbs, or any other light emitting device. It can be advantageous for the light source 260 to emit light having a frequency or plurality of frequencies adapted for the growing of plants. In some embodiments, the light emitting elements 261 can be programmed to flash, to emit light in a given pattern, on a given periodicity or timing, based on the type of plant or desired results. In some embodiments, different light emitting elements 261 can be different types, and/or can emit different types of light, different frequencies, different patterns, or any combination of these.

The system 200 is contained within an environment such that the only significant source of light which the plant can use for photosynthesis is the light source 260. This can be accomplished in a growing house or growing area which is generally blacked out to the sun and other light sources. By limiting the available light to the plant, the phototropic effect can be maximally harnessed to encourage downward (in the z-direction or direction of the net force 270) growth of the plant.

The plant 220 can have a needle 220 inserted therein, with the needle 220 connected to a supply line 227 and a fluid source 230. The needle, supply line 227, and the fluid source 230 can be similar to those described elsewhere herein. As depicted, the methods and systems described herein can include using a light source below the plant as well as a needle to inject water and/or nutrients into the plant.

By growing a plant in a system 200, the plant can move fluid and nutrients throughout its vascular system, for example, toward the leaves and fruit, which tend to develop on the extremities or ends of plant structures, without having to work against the force of gravity. This can result in larger plants and greater yields.

The foregoing description details certain embodiments of the systems, devices, and methods disclosed herein. It will be appreciated, however, that no matter how detailed the foregoing appears in text, the systems, devices, and methods can be practiced in many ways. As is also stated above, it should be noted that the use of particular terminology when describing certain features or aspects of the development should not be taken to imply that the terminology is being re-defined herein to be restricted to including any specific characteristics of the features or aspects of the technology with which that terminology is associated.

It will be appreciated by those skilled in the art that various modifications and changes may be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

All references cited herein are incorporated herein by reference in their entirety. To the extent publications and patents or patent applications incorporated by reference contradict the disclosure contained in the specification, the specification is intended to supersede and/or take precedence over any such contradictory material.

The term “comprising” as used herein is synonymous with “including,” “containing,” or “characterized by,” and is inclusive or open-ended and does not exclude additional, unrecited elements or method steps.

All numbers expressing quantities or other concepts used in this application are to be understood as being modified in all instances by the term “about.” Accordingly, unless indicated to the contrary, the numerical parameters set forth in this application are approximations that may vary depending upon the desired properties sought to be obtained by the present development. The above description discloses several methods and materials of the present development. This development is susceptible to modifications in the methods and materials, as well as alterations in the fabrication methods and equipment. Such modifications will become apparent to those skilled in the art from a consideration of this disclosure or practice of the development disclosed herein. Consequently, it is not intended that this development be limited to the specific embodiments disclosed herein, but that it cover all modifications and alternatives coming within the true scope and spirit of the development.

What is claimed is:

1. A system for growing plants, the system comprising:
an injection device adapted to pierce a surface of a plant;
a supply line in fluid connection with the injection device, the supply line adapted to carry a fluid to the injection device; and
a fluid source in fluid communication with the supply line, the fluid source adapted to apply a motive force to a fluid in order to move the fluid through the supply line, the injection device, and into the plant.

2. The system of claim 1, wherein the injection device is a needle

3. The system of claim 1, wherein the injection device is a microneedle array.

4. The system of claim 1, wherein the fluid comprises nutrients to promote plant growth

5. The system of claim 1, further comprising a plant having a root and at least one stem, and wherein the injection device is inserted into an injection site in the stem near the root.

6. The system of claim 5, wherein the injection device is inserted into the injection site at a downward angle with respect to the direction of stem growth.

7. The system of claim 5, wherein the injection device is inserted into the injection site at an upward angle with respect to the direction of stem growth.

8. The system of claim 5, wherein the plant is disposed in a low or zero gravity environment.

9. A system for growing plants, the system comprising:
a frame for supporting a plant;
a root support for housing a root system of the plant, the root support connected to the frame;
a light source disposed below the frame at a determined distance from the frame so as to promote growth of the plant downward toward the light.

10. The system of claim 9, wherein the root support is connected to the frame on an underside of the frame.

11. The system of claim 10, wherein the root support is connected to the frame on a top side of the frame.

12. The system of claim 9, wherein the light source is disposed at the determined distance from the frame in a direction opposite the direction of gravity.

13. The system of claim 9, wherein the light source comprises a plurality of light emitting elements, wherein the light emitting elements are configured to emit different frequencies of light.

14. The system of claim 9, further comprising
a fluid source mounted to the frame;
a supply line in fluid connection with the fluid source, the supply line adapted to carry a fluid from the fluid source; and
an injection device adapted to pierce a surface of a plant near the root support, wherein the fluid source adapted to apply a motive force to a fluid in order to move the fluid through the supply line, the injection device, and into the plant.

15. A method for growing a plant comprising:
securing a root ball of a plant within a root support, the root support connected to a platform;
illuminating a light source, the light source being disposed below the root support in a direction opposite the force of gravity; and
promoting growth of the plant toward the light source in the direction opposite the force of gravity.

16. The method of claim 15, further comprising:
inserting an injection device into a stem of the plant near the root ball;
connecting a supply line to the injection device, the supply line comprising a lumen to contain a fluid;
connecting the supply line to a fluid source, the fluid source comprising a motive force for moving the fluid; and
injecting the fluid into the plant by the fluid source, supply line, and the injection device.
